(19) United States
(12) Patent Application Publication
(10) Pub. No.: US 2026/0001662 A1
(43) Pub. Date: Jan. 1, 2026

(54) METHOD AND SYSTEM FOR MONITORING THE PERFORMANCE OF A HYDRAULIC SYSTEM OF AN AIRCRAFT

(71) Applicant: Airbus Operations (S.A.S.), Toulouse (FR)

(72) Inventor: Raphaël Cabouat, Toulouse (FR)

(21) Appl. No.: 19/247,105

(22) Filed: Jun. 24, 2025

(30) Foreign Application Priority Data
Jun. 26, 2024 (FR) FR2406859

(51) Int. Cl. B64F 5/60; F15B 19/00; G01K 1/024; G01K 3/00; G01M 99/00; G08B 21/18

(52) U.S. Cl. CPC B64F 5/60; F15B 19/00; G01K 1/024; G01K 3/005; G01M 99/005; G08B 21/182

(57) ABSTRACT

A method for monitoring performance of a hydraulic system of an aircraft includes collecting values of temperature of a hydraulic fluid of the hydraulic system, measured by a sensor during a flight of rank i of the aircraft, determining the value of maximum temperature of rank i, denoted T_{max_i}, from amongst the values collected, calculating at least one temperature variation indicator being a function of T_{max_i}, if this temperature variation indicator is greater than a first threshold, calculating a temperature increase indicator, denoted αᵢ, being a function of a comparison between T_{max_i} and a reference value β, and triggering an alert if αᵢ is greater than a second threshold. It is possible to carry out a monitoring of the performance of this hydraulic system in a simple, reliable manner and allowing potential interruptions in operation to be anticipated by raising maintenance alerts sufficiently early.

### TECHNICAL FIELD

The field of the disclosure herein is that of the monitoring of the state of health (Health Monitoring) and of the maintenance of aircraft.

More precisely, the disclosure herein relates to a method for monitoring the performance of a hydraulic system of an aircraft.

### BACKGROUND

When the aircraft comprises several hydraulic systems (which is generally the case), the solution provided may be implemented for each hydraulic system.

The disclosure herein also relates to a monitoring system adapted to the implementation of such a monitoring method, a computer program product and a storage medium allowing the implementation of such a monitoring method, and a maintenance method relying on such a monitoring method.

Aircraft are subjected to extreme conditions when they are in flight, notably in terms of temperature, pressure and speed variations. The performance of their components must be regularly verified in order to ensure their correct operation.

Preventive or predictive maintenance consists in carrying out checks and repairs before any failure occurs.

In the field of aeronautics, the maintenance notably allows the availability and the performance of an aircraft to be improved by avoiding its immobilization on the ground (AOG, for “Aircraft On Ground”), and the maintenance costs to be reduced by allowing maintenance operations to be identified in advance depending on the real performance characteristics of the aircraft.

The monitoring of the state of health of the aircraft for maintenance purposes comprises the collection of the technical data when the aircraft is powered up, then during the flight and until it is shut down. The data thus collected are notably used to calculate the various indicators on which the maintenance relies, and hence the scheduling of maintenance operations.

The use of the data may take place during the flight (this is then referred to as “In-flight health monitoring”) and/or after the flight (for example if the volume of data to be processed requires more processing resources). The calculations using the data collected may therefore be performed in the aircraft and/or in one or more items of equipment on the ground. In the second case, the equipment (computers) on the ground receive, in real time or off-line, the data collected in the aircraft.

The observation of the state of health of an aircraft over several flights allows the personnel on the ground to take decisions and to plan the maintenance operations in advance, which allows precious execution time to saved. The personnel on the ground can thus take appropriate decisions depending on the criticality, on the logistics and on the future maintenance operations, and to prepare the repairs and the replacements in advance.

In the framework of this maintenance, there exists in particular a need to carry out a monitoring of the performance of a hydraulic system of an aircraft. For this purpose, a solution should be available which is reliable and simple to implement and which allows potential operational interrupts to be anticipated by raising maintenance alerts sufficiently early.

### SUMMARY

A method is provided for monitoring a performance of a hydraulic system of an aircraft, the aircraft being equipped with a temperature sensor measuring values of temperature of a hydraulic fluid of the hydraulic system, the method being implemented by a monitoring system comprising an electronic circuitry, the method comprising, for a given flight, of rank i, of the aircraft:
collect values of temperature measured by the temperature sensor during the flight of rank i;
determine a maximum value of temperature of rank i, denoted T_{max_i}, defined as the maximum value from amongst the values of temperature collected during the flight of rank i;
calculate at least one temperature variation indicator being a function of the value of maximum temperature of rank i, T_{max_i};
if the at least one temperature variation indicator is greater than a first predetermined threshold, calculate a temperature increase indicator, denoted αᵢ, being a function of a comparison between the value of maximum temperature of rank i, T_{max_i}, and a reference value, denoted β; and
trigger a first alert if the temperature increase indicator, αᵢ, is greater than a second predetermined threshold.

Thus, it is possible to carry out a monitoring of the performance of a hydraulic system of the aircraft, by virtue of a solution which is reliable and simple to implement, and which allows potential interruptions in operation to be anticipated by raising maintenance alerts sufficiently early.

According to an embodiment, the method furthermore comprises: calculate an average value of maximum temperature of rank i, denoted [symbol] , defined as a moving average of the value of maximum temperature over a first window of flights comprising the flight of rank i and the [symbol] preceding flights of ranks i− [symbol] w to i−1. Furthermore, the calculation of the at least one temperature variation indicator and the calculation of the temperature increase indicator are performed using the average value of maximum temperature of rank i, [symbol] , instead of the value of maximum temperature of rank i, T_{max_i}.

According to an embodiment, the at least one temperature variation indicator belongs to the group comprising:
a first temperature variation indicator, denoted Δᵢ, being a function of a comparison between the average value of maximum temperature of rank i, [symbol] , and an average value of maximum temperature of rank i− [symbol] , denoted [symbol] ; and
a second temperature variation indicator, denoted σᵢ, being a function of a comparison between the average value of maximum temperature of rank i, [symbol] , and another average value of maximum temperature of rank i, denoted

$${𝒯}_{i}^{W} ,$$

defined as a moving average of the value of maximum temperature over a second window of flights comprising the flight of rank i and the W preceding flights of ranks i−W to i−1, with W>w.

According to an embodiment, the first temperature variation indicator is defined as follows:

$${Δ}_{i} = \frac{-}{} .$$

According to an embodiment, the second temperature variation indicator is defined as follows:

$${σ}_{i} = \frac{{( - )}^{3}}{( {T}_{max} )} ,$$

with [symbol] (Tₘₐₓ) the variance of a variable Tₘₐₓ taking the values T_{max_j} with j∈{i− [symbol] , . . . , i−2, i−1,i}.

According to an embodiment, the method furthermore comprises: correcting the values of temperature collected as a function of the temperature of the ambient air measured outside the aircraft and of the altitude of the aircraft. Furthermore, the determination of the value of maximum temperature of rank i, denoted T_{max_i}, is made from amongst the values of temperature collected during the flight of rank i and corrected.

According to an embodiment, the reference value β is calculated as follows:
if the at least one temperature variation indicator is greater than the first predetermined threshold for the given flight of rank i and if there exists a preceding flight for which the at least one temperature variation indicator has been detected to be greater than the first predetermined threshold, the reference value β is the average value of the temperatures collected and corrected, from the preceding flight for which the at least one temperature variation indicator has been detected to be greater than the first predetermined threshold up to the flight of rank i; and
if the at least one temperature variation indicator is greater than the first predetermined threshold for the given flight of rank i and if there is no preceding flight for which the at least one temperature variation indicator has been detected to be greater than the first predetermined threshold, the reference value β is the average value of the temperatures collected and corrected over a predetermined number of flights preceding the flight of rank i.

According to an embodiment, the temperature increase indicator is defined as follows:

$${α}_{i} = \frac{- β}{β} \times 100 .$$

According to an embodiment, the method furthermore comprises: trigger a second alert if the average value of maximum temperature of rank i, [symbol] is greater than a third predetermined threshold.

According to an embodiment, the temperature increase indicator, αᵢ, is calculated if the at least one temperature variation indicator is greater than the first predetermined threshold and if the average value of maximum temperature of rank i, [symbol] , is greater than a fourth threshold.

A computer program product is also provided, comprising instructions leading to the execution, by a processor, of the method described hereinabove according to any one of its embodiments, when the instructions are executed by the processor.

A storage medium is also provided, storing such instructions.

A system is also provided for monitoring a performance of a hydraulic system of an aircraft, the aircraft being equipped with a temperature sensor measuring values of temperature of a hydraulic fluid of the hydraulic system, the monitoring system comprising an electronic circuitry configured for implementing, for a given flight, of rank i, of the aircraft:
collect values of temperature measured by the temperature sensor during the flight of rank i;
determine a value of maximum temperature of rank i, denoted T_{max_i}, defined as the maximum value from amongst the values of temperature collected during the flight of rank i;
calculate at least one temperature variation indicator being a function of the value of maximum temperature of rank i, [symbol] ;
if the at least one temperature variation indicator is greater than a first predetermined threshold, calculate a temperature increase indicator, denoted αᵢ, being a function of a comparison between the value of maximum temperature of rank i, [symbol] , and a reference value, denoted β; and
trigger an alert if the temperature increase indicator, αᵢ, is greater than a second predetermined threshold.

A method is also provided for maintenance of a hydraulic system of an aircraft, the method comprising:
execute the method described hereinabove according to any one of its embodiments, for monitoring the performance of the hydraulic system; and
in the case of an alert being triggered relating to the performance of the hydraulic system, carry out at least one maintenance operation on the hydraulic system.

### BRIEF DESCRIPTION OF THE DRAWINGS

The aforementioned features of the disclosure herein hereinabove, together with others, will become more clearly apparent upon reading the following description of at least one example embodiment, the description being presented in relation with the appended drawings, amongst which:

FIG. 1 illustrates schematically, as a side view, an aircraft equipped with a system for monitoring the performance of a hydraulic system of the aircraft;

FIG. 2 illustrates schematically one example of a hardware architecture of the system for monitoring the performance of a hydraulic system;

FIG. 3 illustrates schematically one example of an algorithm for monitoring the performance of a hydraulic system; and

FIG. 4 illustrates schematically one example of a maintenance algorithm for a hydraulic system of an aircraft.

### DETAILED DESCRIPTION

An aircraft generally comprises several independent hydraulic systems, also referred to as hydraulic circuits. They are used to actuate almost all of the mobile elements needed for flight, such as the landing gear, the brakes, the flaps, the spoilers, the flight control surfaces, etc. Each hydraulic system has its own reservoir containing a hydraulic fluid under pressure used to transmit the power and the force from one point to another. The simplified typical routing of the hydraulic fluid is as follows: it flows from the reservoir to a high-pressure pump, then successively into a high-pressure filter, into a distributor and into the actuator (piston, hydraulic motor, etc.). For the return, it flows into a low-pressure filter before returning to the reservoir.

In order to comply with the certification standards aimed at minimizing the consequences of a failure, an aircraft typically disposes of three hydraulic systems (circuits), designed so that the crew can continue to maintain the control of the aircraft in the case of failure of one of them (or even in the case of a double failure). Each of these three hydraulic systems is generally named by a separate color: BLUE, GREEN or YELLOW.

For each hydraulic system, the aircraft is equipped with a temperature sensor measuring the temperature of the hydraulic fluid in the reservoir. If the measured temperature is greater than a predetermined threshold (for example 98° C.), an alarm ECAM (for “Electronic Centralized Aircraft Monitor”) of the “HYD X RSVR OVHT” type is generated for the attention of the crew in order to indicate an overheating of the reservoir (with X equal to B, G or Y to indicate the color of the hydraulic system in question). There exist several possible causes of overheating, notably: malfunction of the pump, internal leakage, valve problems, wiring problem, etc. In practice, in the case of overheating on two (or only one) of the three hydraulic systems, the crew takes a decision not to take off (NO GO).

The disclosure herein aims to forestall such an overheating for each hydraulic system, and hence the corresponding ECAM alarm, and thus to avoid a NO GO decision.

As the solution provided may be implemented for each one of the hydraulic systems, in a generic manner, only one hydraulic system is considered in the following part of the description.

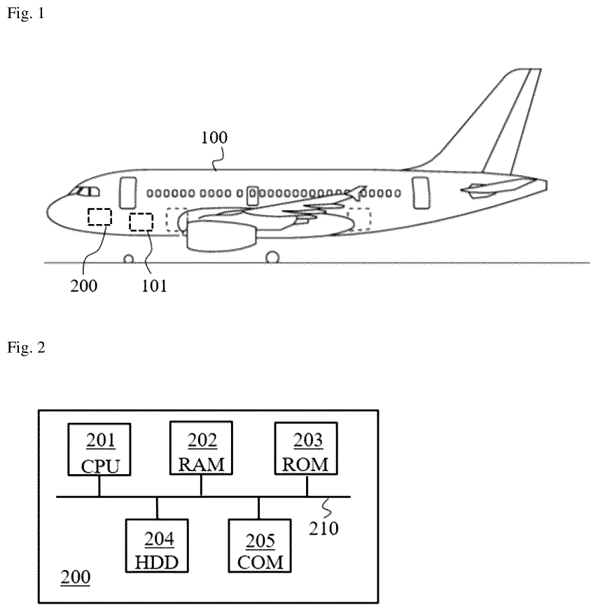

FIG. 1 illustrates schematically, as a side view, an aircraft 100 equipped with a hydraulic system 101 and with a system 200 for monitoring the performance of this hydraulic system.

As detailed in the following, the system 200 for monitoring the performance of the hydraulic system allows an alert to be triggered (for example the display of information and/or the sending of a message to a maintenance service) if a triggering condition is verified. Furthermore, as also detailed in the following, the triggering of an alert relating to the hydraulic system may be followed by at least one maintenance operation on this hydraulic system (for example the repair or the replacement of one or more elements of the hydraulic system).

In an embodiment, the system 200 for monitoring the performance of a hydraulic system is an onboard electronic device. For example, it forms part an electronic circuitry of the avionics of the aircraft 100. Preferably, it is integrated into a computer of the aircraft 100.

In one variant, the system 200 for monitoring the performance of a hydraulic system is not installed on board the aircraft 100 but is present on the ground.

In another variant, the system 200 for monitoring the performance of a hydraulic system comprises a first part which is on board the aircraft 100 and a second part which is present on the ground. Thus, the calculations and the triggering of the alerts may be shared between the two parts of the system 101.

In another variant, at least one system 200 for monitoring the performance of a hydraulic system is carried on board the aircraft and at least one system 200 for monitoring the performance of a hydraulic system is installed on the ground.

FIG. 2 illustrates schematically one example of a hardware architecture of the system 200 for monitoring the performance of a hydraulic system, which then comprises, connected via a communications bus 210: a processor or CPU (Central Processing Unit) 201; a volatile memory RAM (Random Access Memory) 202; a non-volatile memory ROM (Read Only Memory) 203, for example a Flash memory; a device for storing data, such as a hard disk HDD (Hard Disk Drive), or a storage medium reader, such as an SD (Secure Digital) card reader 204; at least one communications interface 205 allowing the monitoring system 200 to interact with the avionics of the aircraft 100.

The processor 201 is capable of executing instructions loaded into the RAM 202 from the ROM 203, from an external memory (not shown), from a storage medium, such as an SD card, or from a communications network (not shown). When the monitoring system 200 is powered up, the processor 201 is capable of reading instructions from the RAM 202 and of executing them. These instructions form a computer program causing the implementation, by the processor 201, of the behaviors, steps and algorithm described here.

All or part of the behaviors, steps and algorithm described here may thus be implemented in software form by execution of a set of instructions by a programmable machine, such as a DSP (Digital Signal Processor) or a microcontroller, or be implemented in hardware form by a machine or a dedicated component (“chip”) or a dedicated set of components (“chipset”), such as an FPGA (Field-Programmable Gate Array) or an ASIC (Application-Specific Integrated Circuit). Generally speaking, the monitoring system 200 comprises electronic circuitry arranged and configured for implementing the behaviors, steps and algorithms described here.

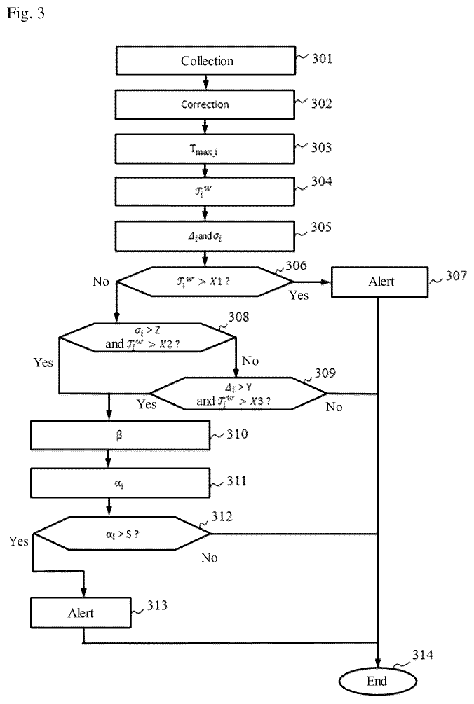

FIG. 3 illustrates schematically one example of an algorithm for monitoring the performance of a hydraulic system of an aircraft. The algorithm (method) is implemented by the monitoring system 200 discussed hereinabove in relation with FIGS. 1 and 2. As already mentioned above, the aircraft is equipped with a temperature sensor measuring values of temperature of a hydraulic fluid of the hydraulic system (for example the temperature in the reservoir of this hydraulic system).

The algorithm is executed for each of the successive flights of the aircraft. The steps of the algorithm are now detailed, by considering an execution for a given flight, of rank i, of the aircraft.

In a step 301, the monitoring system 200 collects values of temperature (of the hydraulic fluid of the hydraulic system being monitored) measured by the temperature sensor during the flight of rank i of the aircraft. In one embodiment, the collection is limited to one or more phases of the flight, for example the cruising phase (phase 6 (“Cruise”) in the case of a breakdown of the flight into ten phases).

In a step 302, the monitoring system 200 corrects the values of temperature collected as a function of the temperature of the ambient air (SAT for “Static Air Temperature”) measured outside the aircraft and of the altitude of the aircraft. This correction is notably aimed at eliminating the seasonality of the measurements.

In a step 303, the monitoring system 200 determines a value of maximum temperature of rank i, denoted T_{max_i}, defined as the maximum value from amongst the values of temperature collected during the flight of rank i and corrected.

In a step 304, the monitoring system 200 calculates an average value of maximum temperature of rank i, denoted [symbol] , defined as a moving average of the value of maximum temperature over a first window of flights comprising the flight of rank i and the [symbol] preceding flights of ranks i− [symbol] to i−1 (for example [symbol] =10). Thus, the average value of maximum temperature of rank i, [symbol] , may be expressed according to the following equation:

$$= \frac{1}{+ 1} {T}_{max \_ j}$$

In a step 305, the monitoring system 200 calculates at least one temperature variation indicator being a function of the average value of maximum temperature of rank i, [symbol] . In an embodiment, the monitoring system 200 calculates two temperature variation indicators, Δᵢ and σᵢ, which are detailed hereinafter. In one variant, the monitoring system 200 calculates only one of these two temperature variation indicators.

The indicator Δᵢ is a function of a comparison between the average value of maximum temperature of rank i, [symbol] , and an average value of maximum temperature of rank i− [symbol] , denoted [symbol] . In an embodiment, the indicator Δᵢ is defined as follows:

$${Δ}_{i} = \frac{-}{}$$

The indicator σᵢ is a function of a comparison between the average value of maximum temperature of rank i, [symbol] , and another average value of maximum temperature of rank i, denoted

$${𝒯}_{i}^{W} ,$$

defined as a moving average of the value of maximum temperature over a second window of flights comprising the flight of rank i and the W preceding flights of ranks i−W to i−1, with W>w (for example, W=5*w). In an embodiment, the indicator σᵢ is defined as follows:

$${σ}_{i} = \frac{{( - {𝒯}_{i}^{W} )}^{3}}{( {T}_{max} )}$$

with [symbol] (Tₘₐₓ) the variance of a variable Tₘₐₓ taking the values T_{max_j} with j∈{i− [symbol] , . . . , i−2, i−1,i}.

The indicator Δᵢ is an indicator of a rapid (abrupt) change of temperature, which occurs for example when a pump of the hydraulic system stops working. The indicator σᵢ is an indicator of a slow (progressive) change of temperature, which occurs for example when there is a leak in the hydraulic system. The indicators Δᵢ and σᵢ are therefore complementary.

In a step 306, the monitoring system 200 verifies whether the average value of maximum temperature of rank i, [symbol] , is greater than a predetermined threshold X1 (for example, X1=65° C.).

In the case of a response “yes” to the test at the step 306, the monitoring system 200 goes to the step 307 in which it triggers an alert (for example the display of information and/or the sending of a message to a maintenance service), then it goes to the end step 314.

In the case of a response “no” to the test at the step 306, the monitoring system 200 goes to the step 308 in which it verifies whether the indicator σᵢ is greater than a predetermined threshold Z (for example, Z=20). In an embodiment of the step 308, the monitoring system 200 furthermore verifies whether another condition is verified, namely whether the average value of maximum temperature of rank i, [symbol] , is greater than a predetermined threshold X2 (for example, X2=55° C.).

In the case of a response “yes” to the test (or double test in the particular embodiment) at the step 308, the monitoring system 200 goes to the step 310 described hereinafter.

In the case of a response “no” to the test at the step 308, the monitoring system 200 goes to the step 309 in which it verifies whether the indicator Δᵢ is greater than a predetermined threshold Y (for example, Y=1). In an embodiment of the step 309, the monitoring system 200 furthermore verifies whether another condition is verified, namely whether the average value of maximum temperature of rank i, [symbol] , is greater than a predetermined threshold X3 (for example, X3=50° C.).

In the case of a response “yes” to the test (or double test in the particular embodiment) at the step 309, the monitoring system 200 goes to the step 310 described hereinafter. In the case of a response “no” to the test at the step 309, the monitoring system 200 goes to the end step 314.

In the step 310, the monitoring system 200 calculates a reference value β as follows:
if there exists a preceding flight for which one of the indicators Δᵢ and σᵢ has been detected to be greater than its associated threshold (Y and Z, respectively), the reference value β is the average value of the temperatures collected and corrected, starting from this preceding flight up to the flight of rank i; and
if there is no preceding flight for which one of the indicators Δᵢ and σᵢ has been detected to be greater than its associated threshold (Y and Z, respectively), the reference value β is the average value of the temperatures collected and corrected, over a predetermined number (for example 75) of flights preceding the flight of rank i.

In a step 311, the monitoring system calculates a temperature increase indicator, denoted αᵢ, being a function of a comparison between the average value of maximum temperature of rank i, [symbol] , and the reference value β. In an embodiment, the indicator αᵢ is defined as follows (so that it may be expressed in the form of a percentage):

$${α}_{i} = \frac{- β}{β} \times 100$$

In a step 312, the monitoring system 200 verifies whether the indicator αᵢ is greater than a predetermined threshold S (for example, S=5%).

In the case of a response “yes” to the test at the step 312, the monitoring system 200 goes to the step 313 in which it triggers an alert (for example the display of information and/or the sending of a message to a maintenance service), then it goes to the end step 314.

In the case of a response “no” to the test at the step 312, the monitoring system 200 goes directly to the end step 314.

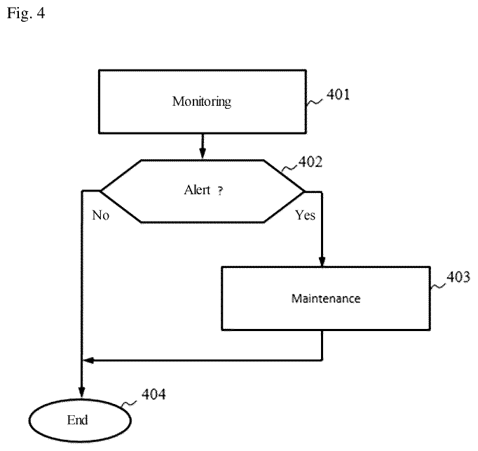

FIG. 4 illustrates schematically one example of an algorithm for maintenance of a hydraulic system of an aircraft.

In a step 401, the monitoring system 200 executes an algorithm for monitoring the performance of a hydraulic system, for example in the particular embodiment described above (see the description of FIG. 3).

If an alert has been triggered after the step 401 (result “yes” at the test step 402), at least one maintenance operation on the given electromechanical switch is carried out (step 403).

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for monitoring a performance of a hydraulic system of an aircraft, the aircraft comprising a temperature sensor for measuring values of temperature of a hydraulic fluid of the hydraulic system, the method being implemented by a monitoring system comprising electronic circuitry, the method comprising, for a given flight, of rank i, of the aircraft:
collecting values of temperature measured by the temperature sensor during the flight of rank i;
determining a value of maximum temperature of rank i, denoted T_(max_i), defined as a maximum value from amongst values of temperature collected during the flight of rank i;
calculating at least one temperature variation indicator being a function of the value of maximum temperature of rank i, T_(max_i);
if the at least one temperature variation indicator is greater than a first predetermined threshold, calculating a temperature increase indicator, denoted αᵢ, being a function of a comparison between the value of maximum temperature of rank i, T_(max_i), and a reference value, denoted β; and
triggering a first alert if the temperature increase indicator, αᵢ, is greater than a second predetermined threshold.

2. The method according to claim 1, comprising calculating an average value of maximum temperature of rank i, denoted [symbol] , defined as a moving average of a value of maximum temperature over a first window of flights comprising the flight of rank i and [symbol] preceding flights of ranks i− [symbol] to i−1;
and in which calculating the at least one temperature variation indicator and calculating the temperature increase indicator are carried out using the average value of maximum temperature of rank i, [symbol] , instead of the value of maximum temperature of rank i, T_(max_i).

3. The method according to claim 2, in which the at least one temperature variation indicator belongs to a group comprising:
a first temperature variation indicator, denoted Δᵢ, being a function of a comparison between the average value of maximum temperature of rank i, [symbol] , and an average value of maximum temperature of rank i− [symbol] , denoted [symbol] ; and
a second temperature variation indicator, denoted σᵢ, being a function of a comparison between the average value of maximum temperature of rank i, [symbol] , and another average value of maximum temperature of rank i, denoted
$${𝒯}_{i}^{W} ,$$
defined as a moving average of the value of maximum temperature over a second window of flights comprising the flight of rank i and the W preceding flights of ranks i−W to i−1, with W>w.

4. The method according to claim 3, in which the first temperature variation indicator is defined as
$${Δ}_{i} = \frac{-}{} .$$

5. The method according to claim 3, in which the second temperature variation indicator is defined as
$${σ}_{i} = \frac{{( - {𝒯}_{i}^{W} )}^{3}}{( {T}_{max} )} ,$$
with [symbol] (Tₘₐₓ) the variance of a variable Tₘₐₓking the values T_(max_j) with j∈{i− [symbol] , . . . , i−2, i−1, i}.

6. The method according to claim 1, comprising:
correcting the values of temperature collected as a function of temperature of ambient air measured outside the aircraft and of altitude of the aircraft, and in which the determination of the value of maximum temperature of rank i, denoted T_(max_i), is made from amongst the values of temperature collected during the flight of rank i and corrected.

7. The method according to claim 6, in which the reference value β is calculated as follows:
if the at least one temperature variation indicator is greater than the first predetermined threshold for the given flight of rank i and if there exists a preceding flight for which the at least one temperature variation indicator has been detected to be greater than the first predetermined threshold, the reference value β is an average value of the temperatures collected and corrected, starting from the preceding flight for which the at least one temperature variation indicator has been detected to be greater than the first predetermined threshold, up to the flight of rank i; and
if the at least one temperature variation indicator is greater than the first predetermined threshold for the given flight of rank i and if there does not exist any preceding flight for which the at least one temperature variation indicator has been detected to be greater than the first predetermined threshold, the reference value β is the average value of the temperatures collected and corrected, over a predetermined number of flights preceding the flight of rank i.

8. The method according to claim 1, in which the temperature increase indicator is defined as
$${α}_{i} = \frac{- β}{β} \times 100.$$

9. The method according to claim 2, comprising triggering a second alert if the average value of maximum temperature of rank i, [symbol] , is greater than a third predetermined threshold.

10. The method according to claim 1, in which the temperature increase indicator, αᵢ, is calculated if the at least one temperature variation indicator is greater than the first predetermined threshold and if the average value of maximum temperature of rank i, [symbol] , is greater than a fourth threshold.

11. A computer program product, comprising instructions leading to execution, by a processor, of the method according to claim 1, when the instructions are executed by the processor.

12. A storage medium, storing a computer program comprising instructions leading to execution, by a processor, of the method according to claim 1, when the instructions are read and executed by the processor.

13. A system for monitoring a performance of a hydraulic system of an aircraft, the aircraft comprising a temperature sensor measuring values of temperature of a hydraulic fluid of the hydraulic system, the monitoring system comprising electronic circuitry configured to, for a given flight, of rank i, of the aircraft:
collect values of temperature measured by the temperature sensor during the flight of rank i;
determine a value of maximum temperature of rank i, denoted T_(max_i), defined as the maximum value from amongst the values of temperature collected during the flight of rank i;
calculate at least one temperature variation indicator being a function of the value of maximum temperature of rank i, [symbol] ;
if the at least one temperature variation indicator is greater than a first predetermined threshold, calculate a temperature increase indicator, denoted αᵢ, being a function of a comparison between the value of maximum temperature of rank i, [symbol] , and a reference value, denoted β; and
trigger an alert if the temperature increase indicator, αᵢ, is greater than a second predetermined threshold.

14. A method for maintenance of a hydraulic system of an aircraft, the method comprising:
executing the method according to claim 1, for monitoring performance of the hydraulic system; and
in case of triggering an alert relating to the performance of the hydraulic system, performing at least one maintenance operation on the hydraulic system.
